(19) United States
(12) Patent Application Publication
(10) Pub. No.: US 2005/0018250 A1
(43) Pub. Date: Jan. 27, 2005

(54) Image storage method and media

(76) Inventor: Raymond Moskaluk, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/627,304

(22) Filed: Jul. 24, 2003

(51) Int. Cl. G06F 15/00

(52) U.S. Cl. 358/1.16; 358/1.15

(57) ABSTRACT

The invention, in one embodiment, is an image storage method comprising receiving a first image; outputting a likeness of the first image on a media based on the first image; and placing an encoded representation of the first image on the media based on the first image. In another embodiment, the invention is an image storage method comprising receiving a first media including an encoded representation of an image; and replicating a likeness of the image on a second media based on the encoded representation of the image. In a further embodiment, the invention pertains to an image storage media, the media comprising a first surface adapted for displaying a likeness of an image; and a second surface configured for storing an encoded representation of the image, the first and second surfaces being in communication with each other. In yet another embodiment the invention pertains to an image processing system comprising means for receiving a first image; means for printing a likeness of the first image on a media; and means for storing an encoded representation of the first image on the media.

### FIELD OF THE INVENTION

The invention relates to image storage.

### BACKGROUND OF THE INVENTION

In taking pictures with a digital camera, it is typical for the camera operator to shoot pictures, print copies of the pictures, save the digital images of the pictures in the camera and continue shooting until the available memory in the camera is full. Typically, the available memory is a computer-readable and rewriteable digital memory in the camera wherein the digital images of the pictures are temporarily stored. A digital image is a computer-readable digital representation of the picture taken by the camera. Reprints of the picture, for example, can be made from the digital images.

At the point when the digital memory in the camera is full, the camera operator may purge the memory by downloading and saving the digital images into a computer-readable storage from which a digital image can be retrieved at a later time to reprint a picture. Alternatively, the camera operator may erase the digital images from memory, without saving the images elsewhere, in which case the original images will not be available to make reprints.

Similarly in taking pictures with a film camera, it is typical for the camera operator to shoot a roll of film, have the roll of film developed, and receive the pictures and the photographic image of the pictures from the developer. The photographic image is the negative from which the picture was printed. At a subsequent time, if another picture is desired, the photographic image of the picture can be taken to the developer to reprint a picture.

A problem with storing original images of pictures, whether digital or photographic, is that as time passes, if the images are not carefully stored and/or are not cross-tabulated with the pictures, the images can get misplaced. If the images get misplaced and cannot be located, then making a reprint of a picture from the original image is impossible. For example, in a typical household, pictures are usually kept in a photo album while the original images are kept elsewhere, e.g., in a shoe box in the case of photographic film images, or in a computer-readable storage e.g., a CD, in the case of digital images. Since storage of the images tends to be disorganized, as time passes and the collection of images grows, it is easy for the householder to forget where a particular image for a picture is located. Hence, finding the original image from which to reprint a picture can be problematic.

Similarly, even if the picture was taken recently but the original image was not saved, or if the picture was taken but the original image was subsequently damaged or destroyed, e.g., the CD or the photographic film was damaged or destroyed, then making a reprint of the picture from the original image will not be possible.

While it is possible to digitally scan an available picture and make a reprint of the picture, if the quality of the picture from which the scan is taken is poor (e.g. the picture is torn, or parts of the picture are missing, or the picture is crumpled or otherwise damaged, etc.) the scanning may not produce a desirable result compared to printing from the original image. Besides, for many pictures, it is desirable to reprint from the original image as the original image provides a better quality reprint compared to alternative means such as scanning the picture. Accordingly, a better way to handle the original image is desired.

### SUMMARY OF THE INVENTION

The invention, in one embodiment, is an image storage method comprising receiving a first image; outputting a likeness of the first image on a media based on the first image; and placing an encoded representation of the first image on the media based on the first image. In another embodiment, the invention is an image storage method comprising receiving a first media including an encoded representation of an image; and replicating a likeness of the image on a second media based on the encoded representation of the image. In a further embodiment, the invention pertains to an image storage media, the media comprising a first surface adapted for displaying a likeness of an image; and a second surface configured for storing an encoded representation of the image, the first and second surfaces being in communication with each other. In yet another embodiment the invention pertains to an image processing system comprising means for receiving a first image; means for printing a likeness of the first image on a media; and means for storing an encoded representation of the first image on the media.

### BRIEF DESCRIPTION OF THE DRAWINGS

The accompanying drawings, which are incorporated in and form a part of this specification, illustrate embodiments of the invention by way of example and not by way of limitation. The drawings referred to in this specification should be understood as not being drawn to scale except if specifically noted.

FIG. 1 is diagram of an exemplary computer system on which embodiments of the present invention can be implemented.

FIG. 2 is a flow chart of an image storage method in accordance with an embodiment of the invention.

FIG. 3 is a flow chart of an alternative image storage method in accordance with an embodiment of the invention.

FIG. 4 is a diagram of an image storage media in accordance with an embodiment of the invention.

FIG. 5 is a diagram of an image processing system of in accordance with an embodiment of the invention.

FIG. 6 is an illustration of an application of the invention in one embodiment wherein a damaged picture is useable to obtain new reprints.

### DETAILED DESCRIPTION OF EMBODIMENTS OF THE INVENTION

Overview

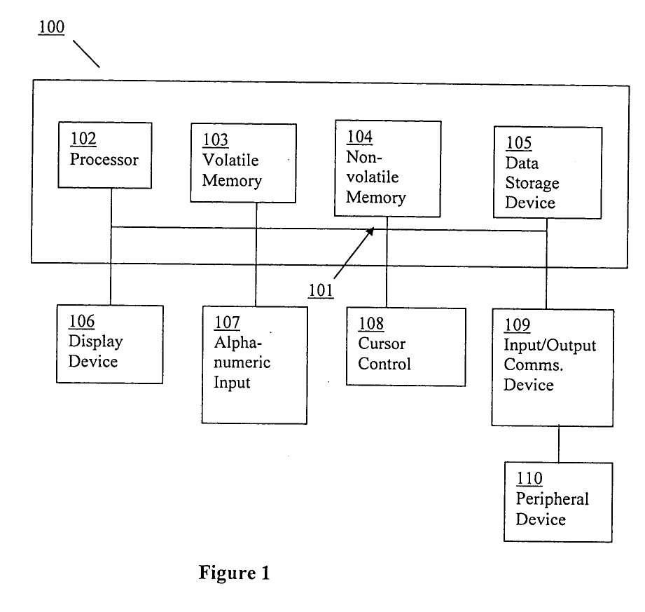

In overview, embodiments of the invention provide for an image storage method, an image processing system and an image storage media. With reference to FIGS. 1-6, in one embodiment, the invention provides for an image storage method 200 comprising receiving an image (e.g., a digital representation of a picture), printing a likeness of the image 403 (e.g., another picture) on a media 400 (e.g. a photographic paper) and placing an encoded representation of the image 404 (e.g., a computer-readable digital representation of the image) on the media 400.

In another embodiment, the invention provides for an image storage method 300 comprising receiving a first media 400 (e.g., a photographic paper) with a likeness of an image 403 (e.g., a picture printed thereon) and an encoded representation of the image 404 thereon (e.g., a computer-readable digital representation of the image). Based on the encoded representation of the image 404 on the first media, a likeness of the image (e.g., a picture) is printed on a second media (e.g., a printing paper).

In yet another embodiment, the invention provides for an image-storage media 400 (e.g., a printing paper). The media comprises a first surface 401 suitably adapted for displaying a likeness of an image 403 (e.g., a picture), and a second surface 402 suitably configured for storing an encoded representation of the image 404 (e.g., a computer-readable digital image of the picture 403).

In a further embodiment, the invention provides for an image processing system 500 comprising means 501 for receiving an image and/or an encoded representation of the image (e.g., image receiving equipment), means 502 for printing a likeness of the image (e.g., picture printing equipment) on a media (e.g., a photographic paper 400), and means 503 for storing an encoded representation of the image on the media (e.g., image storage equipment).

Thus, in accordance with one embodiment of the invention, since the likeness of the image (e.g., a picture) and an encoded representation of the original image (e.g., a computer-readable digital image of the picture) are located on the same media (e.g., photographic paper), storing the picture automatically stores the encoded representation of the picture with the picture. Thus, if it is desired to reprint the picture, the encoded representation of the picture on the picture can be used to obtain the reprint.

Detailed Embodiments

Reference is now made in detail to embodiments of the invention, examples of which are illustrated in the accompanying Figures. While the invention is described in conjunction with the embodiments, it is understood the description is not intended to limit the invention to these embodiments. On the contrary, the invention is intended to cover alternatives, modifications and equivalents that are within the scope of the appended claims.

In the following detailed description of the invention, specific details are set forth in order to describe the invention. However, it is understood the invention may be practiced without all of these specific details. In other instances, generally known methods, procedures and equipment have not been described in detail as not to unnecessarily obscure aspects of the invention.

Some portions of the detailed description that follows are presented in terms of procedures, logic blocks, processing, and other symbolic representations of operations on data bits within a computer memory. These descriptions and representations are the means generally used by those ordinarily skilled in the pertinent art to effectively convey the substance of their work to others ordinarily skilled in the art. A procedure, logic block, process, etc., is here generally conceived to be a sequence of steps or instructions that guide operations of a computer system to a desired result. The steps include physical manipulations of physical quantities. Usually, though not necessarily, these quantities take the form of electrical, magnetic, optical, laser or quantum signals capable of being stored, transferred, combined, compared, and otherwise manipulated in a computer processing system. It is convenient at times, principally for reasons of common usage, to refer to these signals as bits, values, elements, symbols, characters, terms, numbers, or the like.

It should be noted, however, that all of these and similar terms are associated with the appropriate physical quantities and are merely convenient labels applied to these quantities. Unless specifically stated otherwise as apparent from the following discussions, it is appreciated that throughout the present description, discussions utilizing terms such as “receiving”, “storing”, “printing”, “replicating”, “displaying”, “placing” or the like, refer to the action and processes of a computer system, or similar processing device (e.g., an electrical, optical, or quantum computing device), that manipulates and transforms data represented as physical (e.g., electronic) quantities. The terms refer to actions and processes of the processing devices that manipulate or transform physical quantities within a computer system's components (e.g., registers, memories, other such information storage, transmission or display devices, etc.) into other data similarly represented as physical quantities within the same or other components.

Placing an Encoded Representation of an Image on a Media

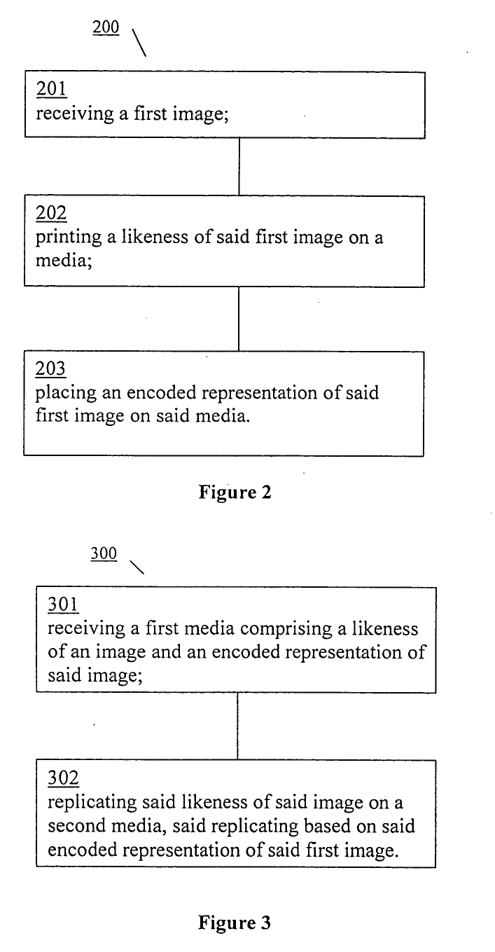

FIGS. 2, 4, 6A and 6B illustrate an image storage method in accordance with an embodiment of the invention. With reference to FIG. 2, step 201 comprises receiving a first image. In one embodiment, the first image is receivable in the form of a photographic negative or positive, for example a 35 mm slide. If received in this form, the image is converted into a computer-readable digital image. The conversion is done by using generally available photographic-to-digital image conversion equipment e.g., a scanner.

In another embodiment, the image is receivable in the form of a digital image downloaded from, for example, a digital camera, a digital video camera, a computer-generated digital image file, a computer-readable digital image file, a digital image copy of a video cassette, a digital image copy of a barcode, a digital image file read from a semiconductor storage, and the like. The computer readable digital image is receivable on a computer-readable media, e.g., a laser-encoded CD, a magnetic storage diskette or a nonvolatile semiconductor memory, or the file is receivable real-time as a digital data stream from a computer network such as by an e-mail file.

In another embodiment, the image is receivable in the form of a picture. In this embodiment, the picture is converted into a computer-readable digital image. The conversion of the picture into a computer-readable image is achievable by any of several known methods including taking a digital photograph of the picture with a digital camera thus creating the encoded digital representation of the image, or optically scanning the picture with an optical scanner to obtain a digital encoded representation of the picture.

Step 202 comprises printing a likeness 403, 603 of the received first image. In one embodiment, printing the likeness 403, 603 of the image on a media 401, 601 includes, but is not limited, to printing a picture of the image on the media and printing a three-dimensional version of the image on the media. The media includes 401, 601, but is not limited to, photographic paper, computer-printable paper, and any other printable media, or any media on which a image is printable. Printing can be done in color or in black and white.

Step 203 comprises placing an encoded representation 404, 604 of the first image on the same media 401, 601 on which the image 403, 603 is printed. In one embodiment, the encoded representation 404, 604 of the image placed on the media 401, 601 includes, but is not limited to, placing an computer-readable digital representation of the image in a magnetic media, or in a nonvolatile semiconductor memory, or in an optically-readable representation of the image e.g., a barcode representation of the image, or in a laser-readable representation of the image, e.g., a CD or a DVD.

The encoded representation 404, 604 of the image is placeable on the media 401, 601 by using generally available equipment. For example, in an embodiment wherein the encoded representation 404, 604 of the image is placed in a nonvolatile semiconductor memory, a computer as set forth in FIG. 1 and described herein can be used to place the encoded representation of the image into the nonvolatile semiconductor memory on the media. Examples of a semiconductor memory include a semiconductor flash memory and semiconductor ROM's and programmable ROM's.

In an embodiment wherein the encoded representation 404, 604 of the image is placed in the form of a barcode on the media, the barcode is placed on the media by a barcode printer. Any suitable, generally available barcode equipment can be used for this purpose.

In an embodiment wherein the encoded representation 404, 604 of the image is placed in a magnetic memory on the media, the encoded representation of the image in the form of a digital image is placed on the media by magnetic read/write head equipment writing a digital copy of the image into a magnetic memory on the media. Any suitable, generally available magnetic read/write equipment can be used for this purpose.

In an embodiment wherein the encoded representation 404, 604 of the image is placed in a laser-readable memory, the image is placed in a laser-readable media, e.g., a polycarbon media such as mylar. The encoded representation 404, 604 of the image can be placed on the media 401, 601 by using a laser beam to encode a digital representation of the image into a mylar layer on the media. Any suitable, generally available equipment suitable for encoding information in a laser-readable memory can be used for this purpose.

In an alternative embodiment, the encoded representation 404, 604 of the image is placed on the media 401, 601 by placing the encoded representation 404, 604 of the image on an adhesive label comprising any of the above described media, e.g., a magnetic media, an optically-readable media, laser-readable media, a nonvolatile semiconductor memory media, and subsequently attaching the label with the encoded representation of the image onto the media.

The placement of the encoded representation 404, 604 of the image on the media 401, 601 varies. Desirably, the encoded representation 404, 604 of the image is placed in an inconspicuous location on the media 401, 601 to avoid obscuring the picture, e.g., it is placed on the back of the picture or on the bottom portion of the picture.

In one embodiment the encoded representation 404, 604 of the image and the picture of the image are placed on the same surface of the media 401, 601 (e.g., on the front surface of a photographic paper). In this embodiment, the picture is placed, for example, on an upper portion of the surface while the encoded representation of the image is placed on a bottom portion of the surface. Other locations on the same surface of the media are possible.

In another embodiment, the encoded representation 404, 604 of the image and the picture are placed on a different surface of the media 401, 601 e.g., the picture is placed on a front surface of the media, while the encoded representation of the image is placed on the back surface of the media. Other locations on the media where the picture and the encoded representation of the image can be placed are possible.

Thus, with this embodiment of the invention, since an encoded representation 404, 604 of the picture and the picture itself 403, 603 are on the same media, a reprint of the picture 403, 603 can be obtained by reading the encoded representation 404, 604 on the picture. As an example, suppose that a wedding picture 600, shown diagrammatically in FIG. 6A, was taken years ago and that in accordance with this embodiment of this invention, an encoded representation 604 of the picture was placed on the picture. In this example, the wedding picture 601 was printed on the front side of the picture, and the encoded representation 604 of the picture, in the form of a barcode representation of the picture, was placed on the back of the picture at the time the picture was printed. The barcode 604 is a typical computer-readable barcode.

Suppose that by the tenth wedding anniversary, the picture 601 has lost its newness, as shown in FIG. 6B. For example, the picture 602 has started to fade, or the paper on which the picture was printed has started to become discolored, or the paper has developed curls, creases or scratches, or that the picture has been torn and otherwise damaged.

Suppose further that for the tenth anniversary occasion, it is desirable to print a new picture, but unfortunately the photographic film negative of the picture or the CD on which the picture image was saved cannot be located.

In accordance with this aspect of the invention, a new picture 603 can easily be reprinted from the aged picture simply by reading the encoded information on the picture i.e., the barcode 604 on the back of the picture. In this regard it should be noted that on encoding the digital image in accordance with the invention, redundant information is encoded such that if portions of the picture are lost or damaged, the redundant information will compensate for such loss or damage and thus the loss or damage will not hamper the reproduction of the picture. If the encoded information is provided in the form of a barcode, any suitable barcode-reading equipment known in the art can be used to read the encoded information.

Further, suppose that at the tenth anniversary occasion, guests are present and that they each desire a copy 603 of the wedding picture. With this embodiment of the invention, multiple copies of the original picture 603 can be easily made by reading the encoded representation 604 and printing out copies.

Thus by this embodiment of the invention it is not necessary to locate a photographic negative film or the CD that contains the original image in order to print a copy of the new picture. The encoded representation of the picture on the picture can be used to print a new picture.

It should be noted that although specific steps of an embodiment of the invention are set forth in flowcharts 200, such steps are exemplary. That is, embodiments of the invention can be performed by various other steps or steps equivalent to those steps set forth in flowchart 200. Also, the steps in flowcharts 200 may be performed in an order different than presented, and not all of the steps in flowchart 200 may be performed. All of, or a portion of, the method set forth in flowcharts 200 may be implemented using computer-readable and computer-executable instructions which reside, for example, in computer-usable media of a computer system 100 or like device. In one embodiment, the steps of flowchart 200 can be implemented by the exemplary computer system 100 of FIG. 1 described below. The embodiments of computer system 100 include a standalone computer system, as well as an embedded computer system, for example, a computer system embedded in an electronic device e.g., a camera.

Replicating an Image Based on an Encoded Representation of the Image on a Media

A method of replicating an image based on using an encoded representation of the image on a first media, in accordance with an embodiment of the invention, is set forth in FIG. 3. In FIG. 3, step 301, a first media comprising a likeness of an image (e.g., a picture) and an encoded representation of the image, or simply an encoded representation of the image, is received. In one embodiment, the first media is any tangible media for displaying an image. The first media includes, but is not limited to photographic paper, printing paper, drawing paper and the like. The likeness of an image is any picture e.g., a photograph of a person or a thing, a drawing, a painting, page of a document and the like. The encoded representation of the likeness of the image received on the first media comprises a computer-readable digital image. In one embodiment, the computer-readable digital image is a digital image saved in magnetic memory on the surface of the first media.

In another embodiment, the computer-readable image comprises a digital image saved in a non-volatile computer-readable semiconductor memory on the surface of the media. Examples of a semiconductor memory include a semiconductor flash memory and semiconductor ROM's and programmable ROM's.

In another embodiment, the computer-readable image comprises an optically-readable representative of the image saved on the surface of the media, e.g., a barcode on the back surface of a photographic paper.

In another embodiment of the invention, the computer-readable image comprises an encoded in a laser-readable memory, e.g., a polycarbon-based memory such as mylar on the surface of the media.

In another embodiment of the invention, the computer-readable image comprises a computer-readable memory that was subsequently attached to the media on which the likeness of the image is printed. For example, the encoded representation of the image was attached onto an adhesive-backed label which is subsequently attached to the media.

In step 302, a likeness of the image (e.g., a picture) received is replicated on a second media, based on the encoded representation of the image on the first media received. In one embodiment, the replication of the picture is achieved by well known printing apparatus e.g., a color printer, a laser printer and the like. The media includes any media for displaying a picture including photographic paper and its equivalents.

Thus, in accordance with this embodiment, a picture, carrying an encoded representation of a picture, is used to obtain a new picture. Equipment well known in the art is useable to read the encoded representation and print the picture. With this embodiment of the invention, as with the embodiment previously described with regard to the wedding picture example, since an encoded representation 404, 604 of the picture and the picture itself 403, 603 are on the same media, a reprint of the picture 403, 603 can be obtained by reading the encoded representation 404, 604 on the picture and print a new picture. Thus also with this embodiment of the invention it is not necessary to locate a photographic negative film or the CD that contains the original image in order to print a copy of the new picture. The encoded representation of the picture on the picture is useable to print a new picture.

It should be noted that although specific steps of an embodiment of the invention are set forth in flowcharts 300, such steps are exemplary. That is, embodiments of the invention can be performed by various other steps or steps equivalent to those steps set forth in flowchart 300. Also, the steps in flowcharts 300 may be performed in an order different than presented, and not all of the steps in flowchart 300 may be performed. All of, or a portion of, the method set forth in flowcharts 300 may be implemented using computer-readable and computer-executable instructions which reside, for example, in computer-usable media of a computer system 100 or like device. In one embodiment, the steps of flowchart 300 can be implemented by the exemplary computer system 100 of FIG. 1 described below.

An Image Storage Media

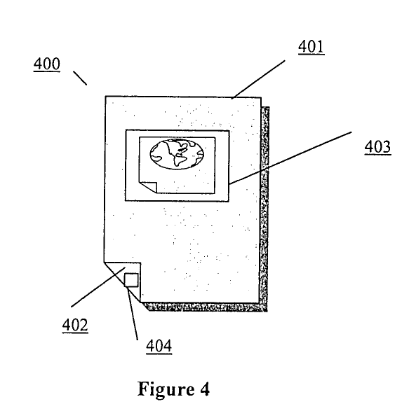

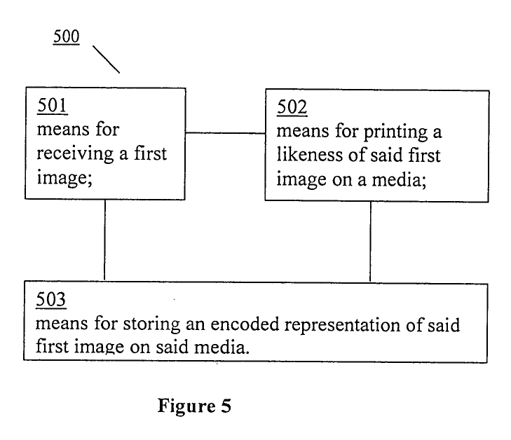

FIG. 4 is a diagram of an image storage media 400 in accordance with an embodiment of the invention. In one embodiment, image storage media 400 comprises a surface 401 adapted for displaying a likeness of an image 403 e.g., a picture or a photograph, and a second surface 402 configured for storing an encoded representation of the image 404, e.g., a computer-readable digital representation of the image.

First surface 401 and second surface 402 are in communication with each other either directly or indirectly on the same media, e.g., in one embodiment first surface 401 is the front side of media 400 and second surface is on the back side of media 400. In another embodiment first surface 401 and second surface 402 are in on the same side the media.

First surface 401 is any computer-printable material and includes, but is not limited to, photographic paper, or computer-printable paper or any other media on which a picture can be printed. A picture 403 includes a photograph and any other picture printable based on a digital representation of the picture. In one embodiment, first surface 401 comprises the same material as second surface 402. In another embodiment, first surface 401 is comprised of a material different from second surface 402.

In one embodiment, second surface 402 is adapted to store in a magnetic memory, an encoded, computer-readable, digital representation 404 of a picture 402 displayable on first surface 401.

In another embodiment, second surface 402 is adapted to store in a computer-readable semiconductor memory, an encoded, computer-readable, digital representation of a picture 404 displayable on first surface 401.

In another embodiment, second surface 402 is adapted to store in an optically-readable format, an encoded, computer-readable, digital representation of a picture 404 displayable on first surface 401.

In another embodiment, second surface 402 is adapted to store in a laser-readable memory, a digital representation of a picture 404 displayable on first surface 401. The laser-readable memory 404 comprises a laser-readable portion e.g. a polycarbon material such as mylar 404, for storing an encoded representation of image placed on first surface 401.

In another embodiment, second surface 402 is adapted to receive an attachable media 404 carrying an encoded representation of a picture 403 displayable on the first surface 401.

Thus, this embodiment of the invention provides for a media for printing a picture and for storing an encoded representation of the picture on the media at the same time. Accordingly, this invention facilitates the printing of a picture without the need for a photographic negative film or the CD that contains the original image of the picture, as with the previously described wedding picture example. The encoded representation of the picture on the picture is useable to print a new picture.

An Image Processing System

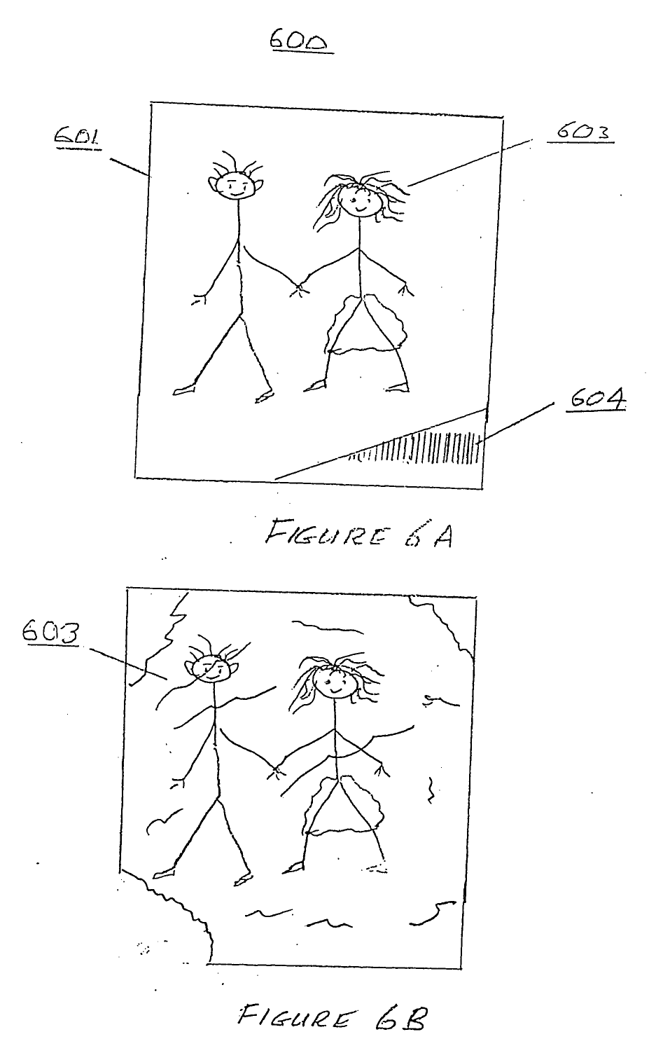

An image processing system 500 in accordance with an embodiment of the invention is shown diagrammatically in FIG. 5. The image processing system 500 comprises means for receiving an image 501; means for printing a likeness of the image 502; and means for storing an encoded representation of the image on the media 503. In one embodiment, image processing system 500 includes means for creating an encoded representation of the image.

In one embodiment, the means for receiving the image 501 includes a suitably configured computer system capable of receiving and reading digitally encoded information. One such computer system 100 is described below in conjunction with FIG. 1. Other computer system well known in the art can be used for this purpose.

The image processable by the image processing system is receivable in one of several formats e.g., a tangible format (e.g., photographic image, or a picture) on a media (e.g., a photographic film, or a photographic paper), or an intangible format in the form of on a computer-readable digital file, or from the encoded image on the picture. The computer readable digital file can be stored on a computer-readable media, e.g., a laser-encoded CD, a magnetic storage diskette or a nonvolatile semiconductor memory, or the file can be received real-time as a data stream from a computer network such as by an by e-mail file, by a computer system such as system 100 of FIG. 1 described below.

The media on which the image is receivable for processing by the system of the invention varies and depends on the format of the image received. For images received in a tangible format, the media includes, but not limited to, printing paper, photographic paper, laser-printable paper, and photographic film of an image of a picture, drawing paper, painting paper and the like. The images receivable may be in color or in black and white.

For images received in an intangible format, the media on which the image is receivable includes, but is not limited to, a CD, a DVD, a photoCD, a magnetic-storage diskette, a video tape, a nonvolatile semiconductor storage, e.g., flash memory, and any other media that can store an image in a computer-readable digital format. Since the image received is in a computer-readable digital format, the image can be transferred directly to a computer system, an example of which is shown in FIG. 1 and described in greater detail below.

If the image is received in a tangible format (e.g., a picture), the image is converted into an intangible, computer-readable format. The conversion of the image into a computer-readable encoded digital format is achieved by any of several known ways including taking a digital photograph of the picture with a digital camera thus creating the encoded digital representation of the image, or optically scanning the image with an optical scanner to obtain a digital encoded representation of the image. On creating a digital version of the image by a digital camera or by a scanner, the image is processed as with the intangible image.

If the image is received in the form of a computer-encoded representation on a picture, then depending on how the image was encoded, the image is read by an appropriate image processing and decoding device, e.g. an optical reader, or a barcode reader, or a computer system capable of processing the encoded image.

In one embodiment of the image processing system, the means for printing a likeness of the first image 502 includes a printer in communication with the means for receiving the image, e.g., the computer system 100 as described below and as shown in FIG. 1. In this embodiment, the printer is capable of taking a digitally encoded representation of the image from the computer system and printing out a picture. Any printer compatible with the computer system can be used for this purpose including a color printer, a black and white printer, a laser printer, an inkjet printer and the like. It should be noted that in one embodiment, a standalone printer can also be used to print the picture.

In one embodiment of the image processing system the means for storing an encoded representation of the image on media 503 includes any equipment capable of taking a digital representation of an image, and storing the digital representation in a digital file on a media. One such means is the computer system 100 shown in FIG. 1 and described in more detail below. Suitable storage media include a nonvolatile semiconductor memory, an optical format, a magnetic memory and laser readable memory.

For example, in the case wherein the encoded representation of the image is a digital image to be stored in a nonvolatile semiconductor memory on the media, the encoded representation of the image is placed in the nonvolatile semiconductor memory by the computer system 100 writing a digital copy of the image into the nonvolatile semiconductor memory on the media. Examples of a semiconductor memory include a semiconductor flash memory and semiconductor ROM's and programmable ROM's.

In an embodiment wherein the encoded representation of the image is placed on the media in the form of an optically-readable code, e.g. a barcode, the optically-readable code is placed on the media by an optical code printer, e.g. a barcode printer. However, any suitable optical device useable with a computer system 100 such as the system shown in FIG. 1 and described below can be used for this purpose. In one embodiment the optical code reading device is in communication with the means for receiving the image to receive the image in a computer-readable digital format.

In an embodiment wherein the encoded representation of the image is placed in a magnetic memory on the media, the encoded representation of the image in the form of a digital image is placed on the media by magnetic read/write head equipment writing a digital copy of the image into a magnetic memory on the media. Any suitable and known magnetic read/write equipment useable with a computer system 100 such as the system shown in FIG. 1 and described below can be used for this purpose.

In an embodiment wherein the encoded representation of the image is placed in a laser-readable memory on the media, the image is placed in a laser-readable media, e.g., a polycarbon media such as mylar. The encoded representation of the image can be placed on the media by using a laser beam to encode a digital representation of the image into a mylar layer on the media. Any suitable and known equipment useable with a computer system 100 such as the system shown in FIG. 1 and described below can be used for encoding information in a laser-readable memory can be used for this purpose.

Alternatively, the encoded representation of the image can be stored by placing the encoded representation of the image on an adhesive-back label comprising any of the above noted media, e.g., a magnetic media, a barcode media, a nonvolatile semiconductor memory media, and subsequently attaching label with the encoded representation of the image to the media.

In one embodiment, the present image processing system is configurable to function in accordance with the image storage methods described herein. Accordingly, with this embodiment of the invention, one can take a damaged picture e.g. a picture as shown in FIG. 6 and, based on the encoded representation thereon, reprint a new picture, as with the previously described wedding picture example. Thus with this embodiment of the invention the photographic negative film or the CD that contains the original image or not required in order to print a copy of new picture. The encoded representation of the picture on the picture can be used to print a new picture.

Computer System for Implementing Embodiments of the Invention

With reference to FIG. 1, embodiments of the invention are comprised of computer-readable and computer-executable instructions that reside, for example, in computer system 100 of FIG. 1, which may be a part of a general purpose computer network (not shown), or may be a stand-alone computer system. It will be appreciated that computer system 100 of FIG. 1 is exemplary only and that the invention can operate within a number of different computer systems including general-purpose computer systems, embedded computer systems, laptop computer systems, hand-held computer systems, stand-alone computer systems and networked computer systems including the Internet.

In an embodiment, computer system 100 includes an address/data bus 101 for conveying digital information between the various components, a central processor unit (CPU) 102 for processing the digital information and instructions, a volatile main memory 103 comprised of volatile random access memory (RAM) for storing the digital information and instructions, and a non-volatile read only memory (ROM) 104 for storing information and instructions of a more permanent nature. In addition, computer system 100 may also include a data storage device 105 (e.g., a magnetic, optical, floppy, semiconductor or tape drive or the like) for storing data. It should be noted that the software program comprising a simulated management infrastructure stack for simulating a real enterprise computing management system or testing a user application in accordance with an embodiment of the invention can be stored either in volatile memory 103, data storage device 105, or in an external storage device (not shown).

Devices which are optionally coupled to computer system 100 include a display device 106 for displaying information to a computer user, an alpha-numeric input device 107 (e.g., a keyboard), and a cursor control device 108 (e.g., mouse, trackball, light pen, etc.) for inputting data, selections, updates, etc. Computer system 100 can also include a mechanism for emitting an audible signal (not shown). Optional display device 106 of FIG. 1 may be a liquid crystal device, cathode ray tube, or other display device suitable for creating graphic images and alpha-numeric characters recognizable to a user.

Computer system 100 can include an input/output (I/O) signal unit (e.g., interface) 109 for interfacing with a peripheral device 110 (e.g., a computer network, modem, mass storage device, etc.). Accordingly, computer system 100 may be coupled in a network, such as a client/server system, whereby a number of clients (e.g., personal computers, workstations, portable computers, minicomputers, terminals, etc.) are used to run processes for performing desired tasks (e.g., “simulating”, or “requesting,” or “receiving,” or “sending”, or “contacting,” or “determining,” or “comparing,” or “generating,” or “printing”, etc.). In particular, computer system 100 can be coupled in a system for executing a software application program that embodies aspects the invention.

The foregoing descriptions of specific embodiments of the present invention have been presented for purposes of illustration and description. They are not intended to be exhaustive or to limit the invention to the precise forms described, and obviously many modifications and variations are possible in light of the above teaching. The embodiments were chosen and described in order to best describe the invention and its practical application. It is intended that the scope of the invention be defined by the claims appended hereto and their equivalents.

1. An image storage method comprising:
receiving a first image;
printing a likeness of said first image on a media; and
placing an encoded representation of said first image on said media.

2. The method of claim 1, wherein said encoded representation of said first image comprises a computer-readable representation of said first image.

3. The method of claim 1, further including creating said encoded representation of said first image.

4. The method of claim 1, further including receiving a picture of said first image.

5. The method of claim 1, wherein said receiving said first image comprises receiving a computer-readable image.

6. The method of claim 1, wherein said receiving said first image comprises receiving a computer-generated image.

7. The method of claim 1, wherein said printing said likeness of said first image comprises printing a picture of said first image on said media.

8. The method of claim 1, wherein said placing said encoded representation of said first image on said media comprises placing said encoded representation of said first image in a computer-readable storage on said media.

9. The method of claim 8, wherein said computer-readable storage comprises a magnetic memory.

10. The method of claim 8, wherein said computer-readable storage comprises a nonvolatile semiconductor memory.

11. The method of claim 8, wherein said computer-readable storage comprises an optically-readable code.

12. The method of claim 8, wherein said computer-readable storage comprises a laser-readable memory.

13. The method of claim 12, wherein said polycarbon memory comprises mylar.

14. The method of claim 1, wherein said placing said encoded representation of said first image on said media comprises attaching said encoded representation of said first image to said media.

15. An image storage method comprising:
receiving a first media comprising an encoded representation of an image; and
replicating a likeness of said image on a second media, said replicating based on said encoded representation of said image.

16. The method of claim 15, wherein said first media includes a picture of said encoded representation of said image.

17. The method of claim 15, further including placing a copy of said encoded representation of said image on said second media.

18. The method of claim 15, wherein said likeness of said image comprises a picture of said image.

19. An image storage media comprising:
a first surface adapted for displaying a likeness of an image; and
a second surface configured for storing an encoded representation of said image, said first and second surfaces being in communication with each other.

20. The image storage media of claim 19, wherein said second surface comprises computer-readable memory for storing said encoded representation of said image.

21. The image storage media of claim 19, wherein said second surface comprises a laser-readable memory for storing said encoded representation of said image.

22. The image storage media of claim 19, wherein said second surface comprises an optically-readable memory for storing said encoded representation of said image.

23. The image storage media of media 19, wherein said second surface comprises a computer-readable memory chip for storing said encoded representation of said image.

24. The image storage of media of claim 19, wherein said laser-readable polycarbon memory comprises mylar.

25. An image processing system comprising:
means for receiving a first image;
means for printing a likeness of said first image on a media; and
means for storing an encoded representation of said first image on said media.

26. The image processing system of claim 25, further including means for creating said encoded representation of said first image.

27. The image processing system of claim 25, wherein said first image is a digital representation of a picture.

28. The image processing system of claim 25, wherein said first image is a photographic image of a picture.

29. The image processing system of claim 25, wherein said encoded representation of said first image includes a computer-readable representation of said first image.

30. The image processing system of claim 25, further including means for reading said encoded representation of said first image.
